(19) United States
(12) Patent Application Publication
(10) Pub. No.: US 2026/0214276 A1
(43) Pub. Date: Jul. 23, 2026

(54) METHODS AND DEVICES FOR SIGNALING AND USING NEURAL NETWORK-BASED FILTERS

(71) Applicant: Tencent America LLC, Palo Alto, CA (US)

(72) Inventors: Motong XU, Palo Alto, CA (US); Roman CHERNYAK, Palo Alto, CA (US); Shan LIU, Palo Alto, CA (US)

(21) Appl. No.: 19/435,173

(22) Filed: Dec. 29, 2025

Related U.S. Application Data
(60) Provisional application No. 63/746,900, filed on Jan. 17, 2025.
(60) Provisional application No. 63/766,369, filed on Mar. 3, 2025.

(51) Int. Cl. H04N 19/70; H04N 19/117; H04N 19/176; H04N 19/196; H04N 19/82; H04N 19/86

(52) U.S. Cl. CPC H04N 19/70; H04N 19/117; H04N 19/176; H04N 19/196; H04N 19/82; H04N 19/86

(57) ABSTRACT

An example method of video decoding includes receiving a video bitstream of video data, the video data comprising a plurality of blocks and reconstructing a block of the plurality of blocks. The method also includes parsing a syntax element from the bitstream, the syntax element indicating whether a neural network-based filter is to be applied to the reconstructed block. When the syntax element indicates that the neural network-based filter is to be applied to the reconstructed block, the neural network-based filter is applied to the reconstructed block. When the syntax element indicates that the neural network-based filter is not to be applied to the reconstructed block, the neural network-based filter is not applied to the reconstructed block.

### RELATED APPLICATIONS

This application claims priority to U.S. Provisional Patent Application No. 63/746,900, entitled “Signaling Methods for Neural Network In-Loop Filter for Machine Tasks,” filed Jan. 17, 2025, and to U.S. Provisional Patent Application No. 63/766,369, entitled “Method and Apparatus for Signaling and Decoding of Neural Network In-loop Filters,” filed Mar. 3, 2025, each of which is hereby incorporated by reference in its entirety.

### TECHNICAL FIELD

The disclosed embodiments relate generally to video coding, including but not limited to systems and methods for applying and signaling neural network-based filters.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Video Coding for Machines (VCM) is an exploration focused on compressing video specifically for automated machine analysis (e.g., AI/vision tasks) rather than human viewing.

### SUMMARY

The present disclosure describes various aspects of video coding including methods and systems for signaling and applying neural network-based filters in video encoding and decoding processes. For example, the disclosed embodiments provide techniques for selectively applying neural network-based filters to reconstructed video blocks based on syntax elements parsed from a video bitstream. The syntax elements may be signaled at various levels, such as sequence-level or picture-level, and may indicate whether the neural network-based filter is to be applied to specific color components. The disclosed techniques enable adaptive filtering that can improve video quality by reducing artifacts while maintaining coding efficiency. Additionally, the disclosed embodiments provide methods for padding reconstructed blocks prior to filtering, clipping filter outputs, and combining neural network filter outputs with outputs from other filters such as deblocking filters, sample adaptive offset filters, and adaptive loop filters. These techniques provide flexibility in the filtering process, allowing encoders to optimize video quality based on content characteristics while enabling decoders to accurately reconstruct the filtered video based on signaled parameters, thereby improving overall coding performance and visual quality of decoded video.

In accordance with some embodiments, a method of video decoding includes (i) receiving a video bitstream of video data, the video data comprising a plurality of blocks; (ii) reconstructing a block of the plurality of blocks; (iii) parsing a syntax element from the bitstream, the syntax element indicating whether a neural network-based filter is to be applied to the reconstructed block; (iv) when the syntax element indicates that the neural network-based filter is to be applied to the reconstructed block, applying the neural network-based filter to the reconstructed block; and (v) not applying the neural network-based filter to the reconstructed block when the syntax element indicates that the neural network-based filter is not to be applied to the reconstructed block.

In accordance with some embodiments, a method of video encoding includes (i) receiving video data comprising a plurality of blocks; (ii) determining whether a neural network-based filter is to be applied to a block of the plurality of blocks; (iii) when the neural network-based filter is to be applied to the block, applying the neural network-based filter to the block; and (iv) not applying the neural network-based filter to the block when the neural network-based filter is not to be applied to the block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates example in-loop filtering stages in accordance with some embodiments.

FIG. 4B illustrates an example neural network-based filter in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

Video compression can be used for not only human but also machine consumptions. Video Coding for Machines (VCM) represents an approach to video compression that targets automated machine analysis tasks, such as object detection and tracking, rather than human viewing. In VCM and other video coding frameworks, neural network-based in-loop filters may be employed to enhance the quality of reconstructed video data. These neural network-based filters can reduce artifacts introduced during the encoding and decoding process, thereby improving the accuracy of downstream machine vision tasks or the visual quality of displayed video. The disclosed embodiments provide methods for signaling and applying such neural network-based filters within a video coding pipeline. For example, a method of video decoding may include receiving a video bitstream comprising a plurality of blocks, reconstructing a block, parsing a syntax element from the bitstream that indicates whether a neural network-based filter is to be applied to the reconstructed block, and selectively applying or not applying the neural network-based filter based on the parsed syntax element. By signaling filter application at various levels within the bitstream, such as sequence-level or picture-level, the disclosed techniques enable adaptive control over the filtering process. This approach may provide flexibility for encoders to optimize filtering decisions based on content characteristics while allowing decoders to accurately reconstruct filtered video according to the signaled parameters, which may improve coding efficiency and reconstruction quality.

### Example Systems and Devices

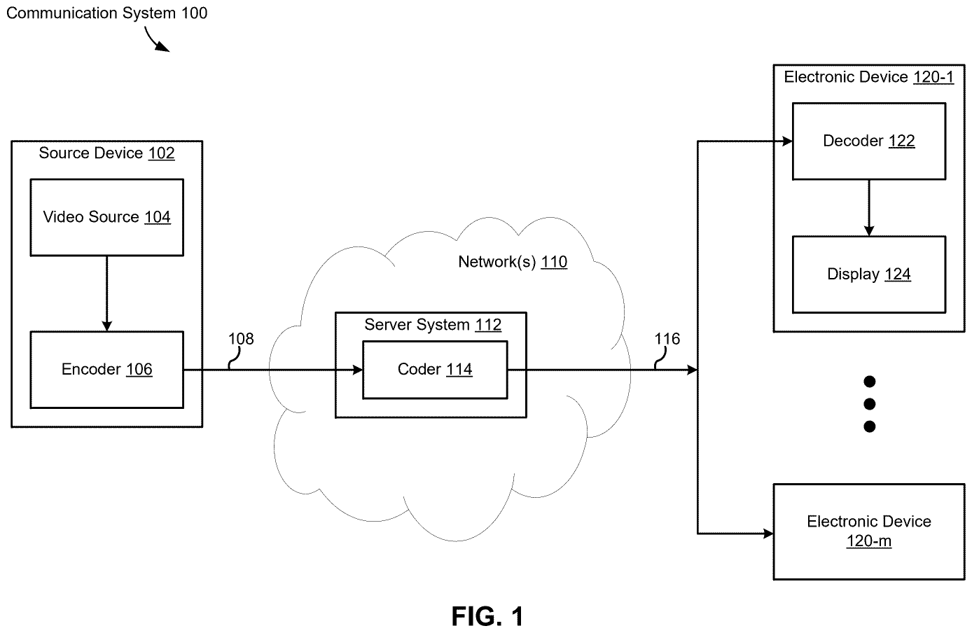

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

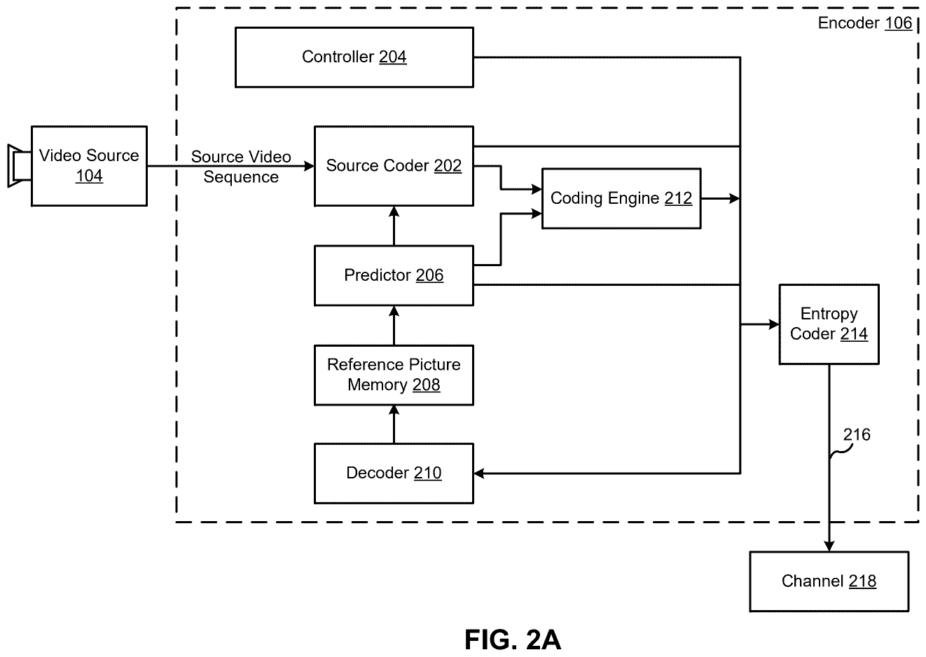

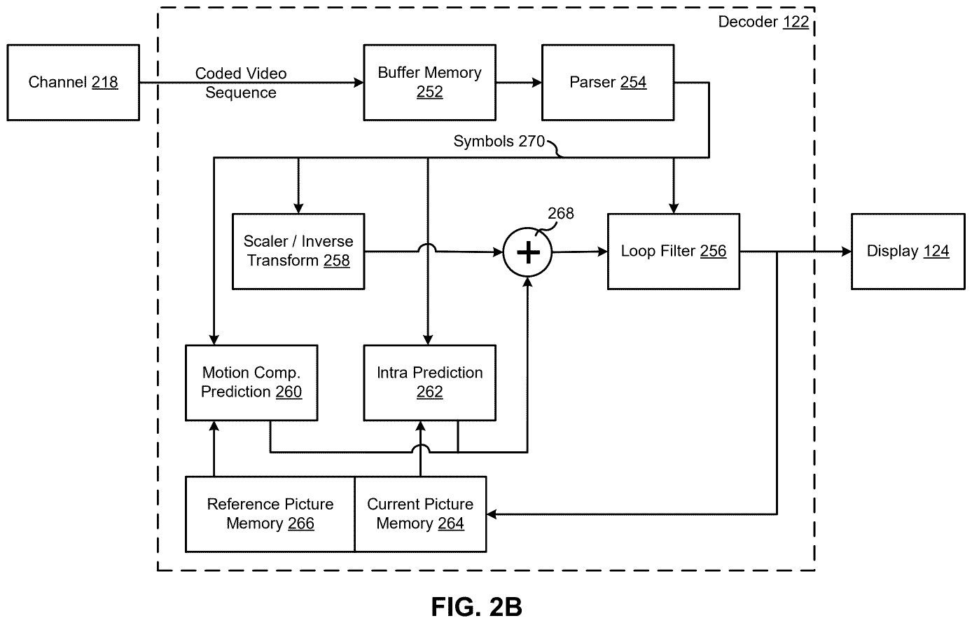

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

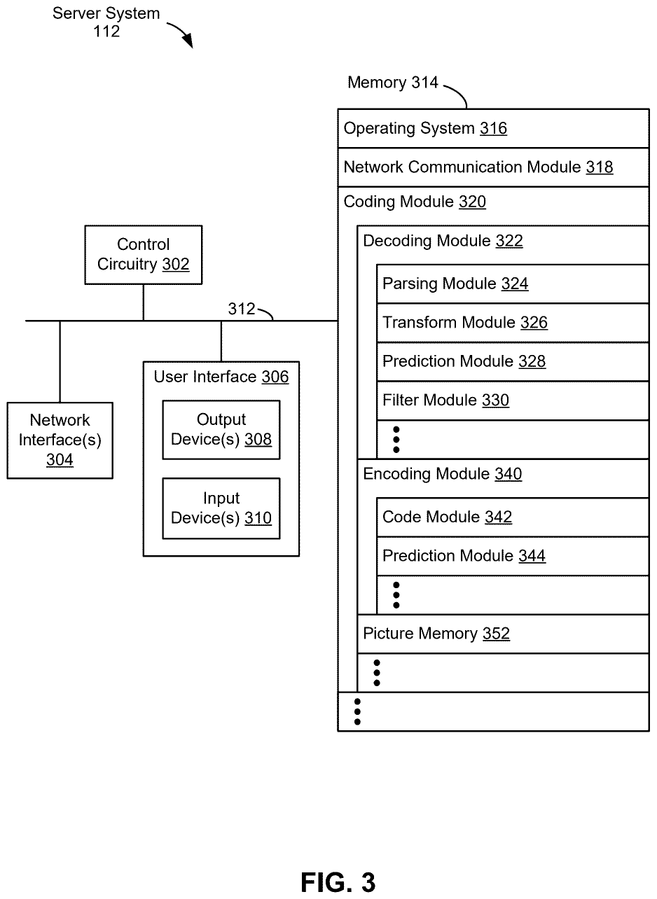

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, a neural network-based filter may be applied to improve the quality of reconstructed images and video.

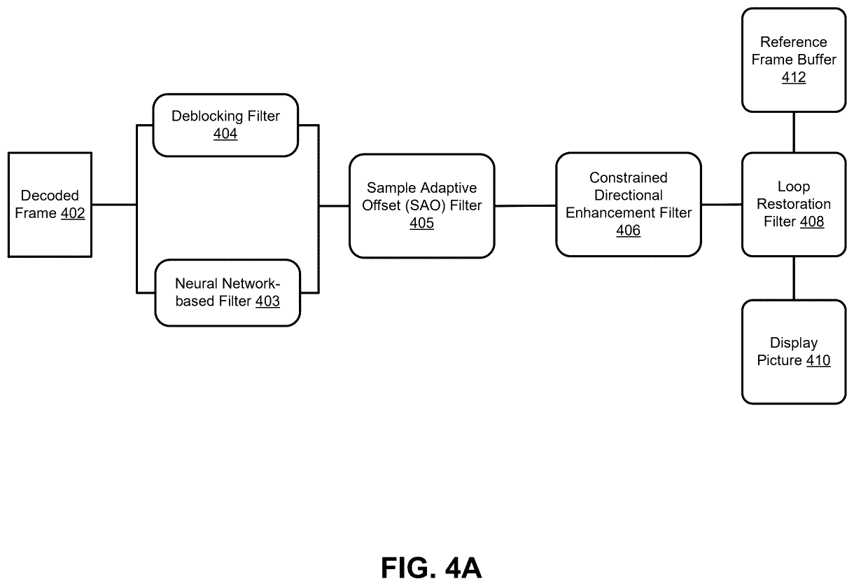

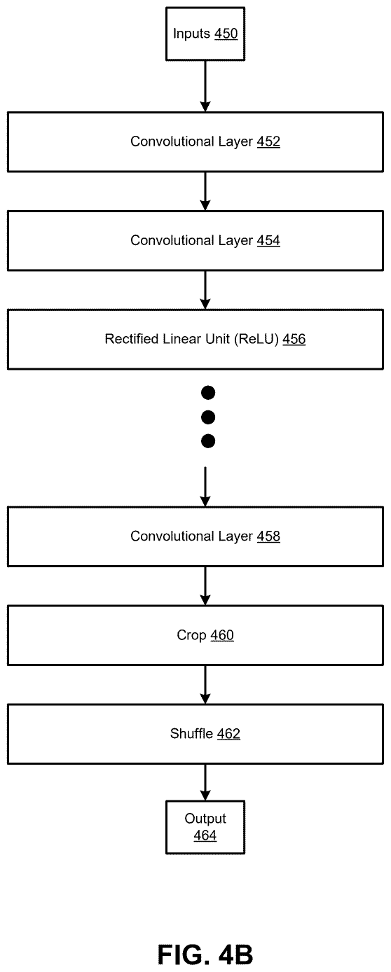

FIG. 4A illustrates example in-loop filtering stages in accordance with some embodiments. As shown in FIG. 4A, a decoded frame 402 (e.g., a reconstructed frame) is provided as input to the filtering pipeline. The decoded frame 402 is processed through multiple filtering stages before being output as a display picture 410 and/or stored in a reference frame buffer 412 for use in subsequent inter-prediction operations. In the illustrated embodiment, the decoded frame 402 is provided to two parallel filtering paths: a first path including a deblocking filter 404 and a second path including a neural network-based filter 403. The outputs from both the deblocking filter 404 and the neural network-based filter 403 are combined and provided to a sample adaptive offset (SAO) filter 405. The SAO filter 405 processes the combined outputs and forwards the result to a constrained directional enhancement filter (CDEF) 406. The CDEF 406 processes the filtered data and provides its output to a loop restoration filter 408, which generates the final filtered output for both display and reference storage.

In some embodiments, the neural network-based filter 403 is arranged in parallel with other filtering components. For example, the neural network-based filter 403 may be arranged in parallel with the SAO filter 405, such that the outputs of the neural network-based filter 403 and the SAO filter 405 are combined before being provided to subsequent filtering stages. In some embodiments, the neural network-based filter 403 is arranged in parallel with the CDEF 406 or other loop filter. In some embodiments, the output of the neural network-based filter 403 is blended with unfiltered reconstructed samples from the decoded frame 402. The filtering pipeline may include additional or alternative loop filters depending on the video coding standard being implemented. In some embodiments, the filtering process includes an adaptive loop filter (ALF) and the output of the neural network-based filter 403 is blended with the output of the ALF. As an example, the filtering pipeline may include a cross-component sample offset (CCSO) filter that derives correction offsets for chroma samples based on neighboring luma sample values or local luma gradients. The CCSO filter may operate concurrently with the CDEF 406, using reconstructed samples following deblocking as input for both filters. In some embodiments, the order of the filtering stages may be rearranged, or certain filtering stages may be omitted or bypassed based on signaled syntax elements in the bitstream. The parallel arrangement of the neural network-based filter 403 with traditional filters such as the deblocking filter 404 enables adaptive filtering that can improve video quality by reducing artifacts while maintaining coding efficiency.

The deblocking filter 404 is an in-loop filtering process configured to reduce visible discontinuities that occur along block boundaries as a result of block-based transform coding and quantization. In some embodiments, the deblocking filter 404 is applied across the transform block boundaries to remove block artifacts caused by the quantization error. The filter operates adaptively along horizontal and vertical edges of coded blocks, detecting discontinuities in pixel intensity across block boundaries and selectively smoothing those edges when the difference exceeds a context-dependent threshold. By reducing blocking artifacts in reconstructed frames prior to their use as reference frames for inter prediction, the deblocking filter improves both subjective visual quality and overall coding efficiency.

In some embodiments, filtering strength and direction are determined based on local coding parameters, such as quantization level, prediction mode, and motion information, to preserve true image edges while attenuating artificial ones. In some embodiments, a filter length is determined based on the minimum transform block sizes on both sides. In some embodiments, finite impulse response (FIR) filters (e.g., low-pass filters) are used by the deblocking filter 404. Edge detection may be used to disable the deblocking filter at transitions that contain a high variance signal (e.g., to avoid blurring an actual edge in the original image). In this way, a deblocking filtering method may be applied on reconstructions samples located close to block boundaries. The block boundaries may include a transform block boundary, a motion compensation block boundary, a coding block boundary, and/or a fixed block size boundary.

The CDEF filter 406 is an in-loop filtering process designed to suppress ringing and other directional artifacts that remain after block-based reconstruction. For each 8×8 block of reconstructed pixels, CDEF 406 first performs direction detection, followed by filtering. The direction detection is performed on reconstructed pixels by computing against D direction patterns. In some embodiments, in CDEF filter 414, there are 8 possible predefined edge directions, corresponding to different angular slope (e.g., 0°, 45°, 90°, 135°, 22.5°, 67.5°, 112.5°, and 157.5°), as illustrated in FIG. 4A. To determine the dominant direction, CDEF filter 406 projects pixel intensities onto a set of lines along direction d; computes the sum of squared differences (SSD) between actual pixels and the mean value along each projected line; and selects as the block's dominant direction the direction that minimizes the SSD (or equivalently maximizes directional correlation). In some embodiments, because the pixel directions are not continuous, the selected direction is encoded as an integer from 0 to 7. This index is later used by the CDEF filter 406 filter to determine which neighboring pixels to include, and how to weight them (e.g., stronger weights along the edge direction, weaker across it). After determining the dominant edge direction of an 8×8 block, CDEF filter 406 applies two sets of directional filters: (i) a primary filter, aligned along the detected dominant direction, and a secondary filter, oriented diagonally (±45°) relative to the dominant direction. For direction d (e.g., the identified dominant direction), a set of neighboring pixels corresponding to direction d are used for primary filter, and another set of neighboring pixels corresponding to 45° away from direction d are used for secondary filter. The filter coefficients and location of neighbors are associated with d. Primary strength and secondary strength (and a damping factor) are used in the computation of the nonlinear filtering on the difference between current pixel and a neighboring pixel for primary and secondary filter, and the result of the nonlinear filter is to be multiplied with the associated filter coefficient, and summed together with the original pixel, to be the final filtered pixel. By enhancing structural coherence while avoiding over-smoothing, CDEF filter 414 improves perceptual quality and provides cleaner, directionally consistent reference frames for subsequent inter prediction stages.

In some embodiments, the loop filtering includes a CCSO filter. The CCSO filter may be applied to reduce residual color artifacts by compensating for correlation between luma and chroma components after prediction and reconstruction. The CCSO filter can derive correction offsets for chroma samples as a function of neighboring luma sample values or local luma gradients, and applies these offsets to adjust the reconstructed chroma signals. In some embodiments, the CCSO filter uses a co-located reconstructed sample and neighboring reconstructed samples from a first color component as input, to perform filtering of the current reconstruction sample of a second color component. In some embodiments, the CCSO filter uses the co-located reconstructed sample and its neighboring reconstructed samples from a first color component as input, to derive an offset value that is added on the current sample of a second color component to adjust its reconstruction value. The first color component may refer to a luma color component, and the second color component may refer to a chroma color component. The first color component and second color component may be the same color component (e.g., a luma component). The CCSO filter may produce offset values, which are added to the reconstructed samples of the luma and chroma components to reduce reconstruction error. In some embodiments, the CCSO filter operates concurrently with CDEF. For example, the reconstructed samples following deblocking may be used as input for both the CDEF and the CCSO filter. By using inter-component statistical dependency, the CCSO filter improves chroma prediction accuracy, reduces color bleeding and blocking artifacts, and enhances overall coding efficiency without requiring additional transform or motion information, thereby providing adaptive post-reconstruction refinement with minimal signaling overhead.

In some embodiments, the loop restoration filter 408 is applied to reconstructed pixels after any prior in-loop filtering stages. The loop restoration filter 408 may be applied to loop restoration units (LRU), e.g., 64×64, 128×128, and/or 256×256 pixel blocks. Bypass filtering, a wiener filter (e.g., a wiener loop filtering method), and/or a self-guided filter may be applied to each LRU independently. A wiener loop filtering method may use a linear weighted sum of the current reconstruction sample and multiple spatially neighboring reconstruction samples as input to derive a modified value for the current reconstruction sample as the output.

In some embodiments, the enablement and parameters of loop filtering operations are signaled in the bitstream at various levels. For example, a sequence-level syntax element may indicate whether a particular loop filter is enabled for an entire coded video sequence, while a picture-level syntax element may indicate whether the loop filter is enabled for a specific picture. In some embodiments, the loop filter parameters are signaled in a sequence parameter set, a picture parameter set, an adaptation parameter set, a slice header, a picture header, and/or other high-level syntax structures. In some embodiments, block-level syntax elements indicate whether a loop filter is to be applied to individual coding tree units, coding units, or other block structures. In some cases, the decoder may derive loop filter enablement or parameters based on other coded information without explicit signaling. For example, the decoder may infer loop filter parameters based on quantization parameters, slice type, temporal layer information, or other coding characteristics. In some embodiments, a combination of signaled and derived parameters is used, where certain parameters are explicitly signaled in the bitstream while other parameters are derived by the decoder based on the signaled values or other coding context. The signaling of loop filter enablement and parameters may be performed independently for each color component, allowing different filtering configurations to be applied to luma and chroma samples.

FIG. 4B illustrates an example neural network-based filter in accordance with some embodiments. As shown in FIG. 4B, the neural network-based filter receives inputs 450, which represent the data to be processed. The inputs 450 are passed through a series of convolutional layers, including a convolutional layer 452 and a convolutional layer 454, which perform convolution operations on the input data. A rectified linear unit (ReLU) 456 applies a non-linear activation function to the convolved data. Additional convolutional layers and activation functions may be included in the neural network architecture, as indicated by the ellipsis in FIG. 4B. A convolutional layer 458 performs another convolution operation, followed by an optional crop 460 operation that extracts a portion of the processed data. An optional shuffle 462 operation rearranges the data elements to produce an output 464, which represents the filtered result. The number and arrangement of convolutional layers and ReLU activation layers may be varied based on the desired filtering characteristics, computational complexity constraints, and/or quality requirements. For example, additional convolutional layers may be added to increase the receptive field of the filter, or the number of ReLU layers may be adjusted to modify the non-linear processing capabilities of the neural network-based filter.

In some embodiments, the neural network-based filter receives multiple input arrays that provide information about the reconstructed video data and associated coding parameters. The inputs may include a reconstructed picture sample array for one or more color components, such as a luma component and chroma components (e.g., Cb and Cr). In some embodiments, the inputs may also include a prediction picture sample array for one or more color components, which represents the prediction samples used during the encoding process. A boundary strength picture sample array may be provided as input, indicating the boundary strength values associated with block boundaries in the reconstructed picture. In some embodiments, quantization parameter information is provided as input to the neural network-based filter, such as a sequence-level quantization parameter and/or a slice-level quantization parameter. The quantization parameter information may be represented as a tensor or array having dimensions corresponding to the picture dimensions. In some embodiments, an intra block prediction picture sample array is provided as input, indicating whether blocks were coded using intra prediction. The inputs may be organized as tensors with dimensions corresponding to the height and width of the block or picture being filtered, along with a channel dimension representing different input features.

In some embodiments, the output of the neural network-based filter includes a modified picture sample array for one or more color components. The output may represent residual values that are added to the reconstructed samples to produce filtered samples. In some embodiments, the output tensor has dimensions that correspond to a downsampled version of the input dimensions, such as half the height and half the width of the input block. The output may include separate channels for luma and chroma components. In some embodiments, the output of the neural network-based filter is combined with the reconstructed samples by adding the neural network output to the corresponding reconstructed sample values. A clipping operation may be applied to the combined output to constrain the sample values within a valid range determined by the bit depth of the video data.

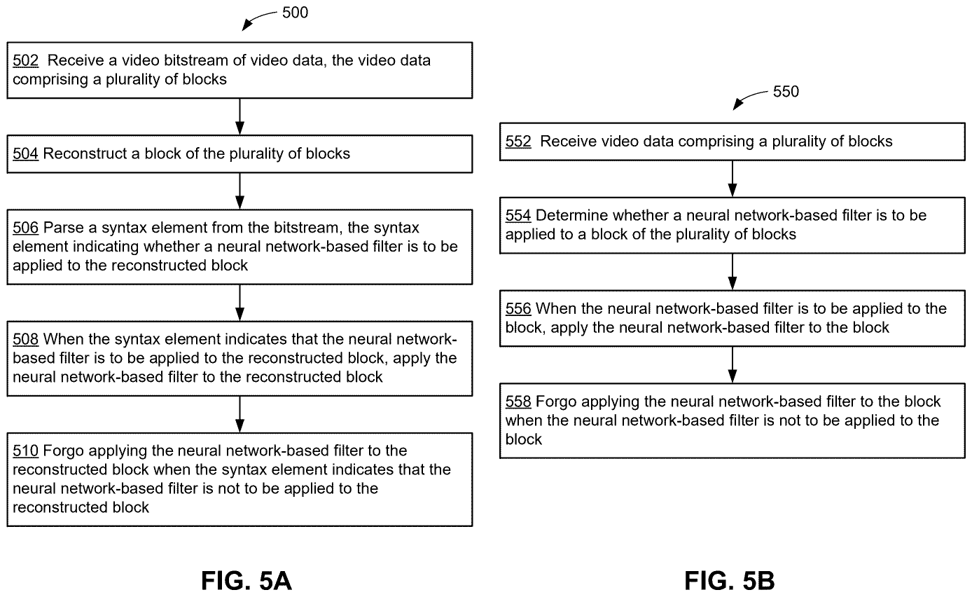

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The computing system receives (502) a video bitstream of video data, the video data comprising a plurality of blocks. The system reconstructs (504) a block of the plurality of blocks. The system parses (506) a syntax element from the bitstream, the syntax element indicating whether a neural network-based filter is to be applied to the reconstructed block. when the syntax element indicates that the neural network-based filter is to be applied to the reconstructed block, the system applies (508) the neural network-based filter to the reconstructed block. The system forgoes (510) applying the neural network-based filter to the reconstructed block when the syntax element indicates that the neural network-based filter is not to be applied to the reconstructed block. In some embodiments, the neural network-based filter is a neural network-based loop filter (NNLF). In this way, a neural network based in-loop (or post filter) may be inside a video codec, such as VCM.

In some embodiments, a usage flag and/or parameter(s) of NNLF are signaled in the raw byte sequence payloads (RBSP) in VCM NAL unit. In some embodiments, the sequence-level enabling flag is signaled in sequence restoration (SRD) syntax.

TABLE 1
Example SRD syntax

| | Descriptor |
|---|---|
| sequence_restoration_data_rbsp ( ) { | |
| . . . | |
| srd_nnlf_enabled_flag | u(1) |
| if( srd_nnlf_enabled_flag ) | |
| nnlf_seq_parameters ( ) | |
| . . . | |
| } | |

In Table 1, srd_nnlf_enabled_flag equal to 1 specifies that neural network in-loop filter is enabled, and srd_nnlf_enabled_flag equal to 0 specifies that neural network in-loop filter is disabled.

In some embodiments, a picture-level enabling flag is signaled in the picture restoration data RBSP syntax.

TABLE 2
Example picture-level syntax

| | Descriptor |
|---|---|
| picture_restoration_data_rbsp ( ) { | |
| . . . | |
| prd_nnlf_enabled_flag | u(1) |
| if ( prd_nnlf_enabled_flag ) | |
| nnlf_pic_parameters ( ) | |
| . . . | |
| } | |

In Table 2, prd_nnlf_enabled_flag equal to 1 specifies that neural network in-loop filter is enabled, and prd_nnlf_enabled_flag equal to 0 specifies that neural network in-loop filter is disabled.

In some embodiments, sequence-level NNLF parameters are signaled when nnlf_seq_parameters( ) is called.

TABLE 3
Example sequence-level syntax

| | Descriptor |
|---|---|
| nnlf_seq_parameters | |
| nnlf_infer_size_base | ue(v) |
| nnlf_infer_size_ext | ue(v) |
| nnlf_max_num_params | ue(v) |
| } | |

In Table 3, nnlf_infer_size_base specifies the base block size for the NNLF inference process, and nnlf_infer_size_ext specifies the extension or padding size on a base block for the NNLF inference process.

In some embodiments, the variables NnlfBlockWidth, NnlfBlockHeight, PicWidthInNnlfBlocks and PicHeightInNnlfBlocks are derived as follows. NnlfBlockWidth=nnlf_infer_size_base+2*nnlf_inf_size_ext. NnlfBlockHeight=nnlf_infer_size_base+2*nnlf_inf_size_ext. PicWidthInNnlfBlocks=Ceil (PicWidth÷NnlfBlockWidth). PicHeightInNnlfBlocks=Ceil (PicHeight÷NnlfBlockHeight). In Table 3, nnlf_max_num_params specifies the number of parameters for the NNLF process.

In some embodiments, the picture-level NNLF parameters are signaled when nnlf_pic_parameters( ) is called.

TABLE 4
Example Picture-Level Syntax

| | Descriptor |
|---|---|
| nnlf_pic_parameters ( ) { | |
| nnlf_mode | u(1) |
| nnlf_scale_mode | ue(v) |
| if( nnlf_scale_mode == 1 ) { | |
| for( i = 0; i < nnlf_mode == 0 ? 1 : nnlf_max_num_params; i++) | |
| { | |
| y_nn_scale[ i ] | ue(v) |
| cb_nn_scale[ i ] | ue(v) |
| cr_nn_scale[ i ] | ue(v) |
| } | |
| } | |
| for( i = 0; i < nnlf_mode == 0 ? 1 : nnlf_max_num_params; i++ ) { | |
| y_roa_flag[i] | u(1) |
| if ( y_roa_flag[i] != 0 ) { | |
| y_roa_offset[i] | ue(v) |
| } | |
| cb_roa_flag[i] | u(1) |
| if ( cb_roa_flag[i] != 0 ) { | |
| cb_roa_offset[i] | ue(v) |
| } | |
| cr_roa_flag[i] | u(1) |
| if ( cr_roa_flag[i] != 0 ) { | |
| cr_roa_offset[i] | ue(v) |
| } | |
| } | |
| if( nnlf_mode == 0 ){ | |
| nnlf_param_id[0][0] | ue(v) |
| } else { | |
| for( y = 0; y < PicHeightInNnlfBlocks; y++) { | |
| for( x = 0; x < PicWidthInNnlfBlocks; x++) { | |
| use_nnlf[x][y] | u(1) |
| if(NumParams != 1 && use_nnlf[x][y]) { | |
| nnlf_ param_id[x][y] | ue(v) |
| } | |
| } | |
| } | |
| } | |
| } | |

In Table 4, nnlf_mode specifies the NNLF processing mode. If nnlf_mode equals to 0, NNLF is enabled at the current picture level. Otherwise (if nnlf_mode equals to 1) NNLF is enabled at block level. In Table 4, nnlf_scale_mode specifies the blending mode used for NNLF, and y_nn_scale[i] specifies the weight used for blending with the deblocking filter results for i-th parameter for Y color component. When not present, the value of y_nn_scale[i] is inferred to be equal to 0. In Table 4, cb_nn_scale[i] specifies the weight used for blending with the deblocking filter results for i-th parameter for Cb color component. When not present, the value of cb_nn_scale[i] is inferred to be equal to 0. In Table 4, cr_nn_scale[i] specifies the weight used for blending with the deblocking filter results for i-th parameter for Cr color component. When not present, the value of cr_nn_scale[i] is inferred to be equal to 0. In Table 4, y_roa_flag[i] equal to 1 specifies that the residual offset adjustment is enabled for i-th parameter for Y color component. y_roa_flag equal to 0 specifies that the residual offset adjustment is disabled for for i-th parameter Y color component. In Table 4, y_roa_offset[i] specifies the residual offset adjustment value for i-th parameter for Y color component. When not present, the value of y_roa_offset[i] is inferred to be equal to 0. In Table 4, cb_roa_flag[i] equal to 1 specifies that the residual offset adjustment is enabled for i-th parameter for Cb color component. cb_roa_flag equal to 0 specifies that the residual offset adjustment is disabled for for i-th parameter Cb color component. In Table 4, cb_roa_offset[i] specifies the residual offset adjustment value for i-th parameter for Cb color component. When not present, the value of cb_roa_offset[i] is inferred to be equal to 0. In Table 4, cr_roa_flag[i] equal to 1 specifies that the residual offset adjustment is enabled for i-th parameter for Cr color component. cr_roa_flag equal to 0 specifies that the residual offset adjustment is disabled for i-th parameter for Cr color component. In Table 4, cr_roa_offset[i] specifies the residual offset adjustment value for i-th parameter for Cr color component. When not present, the value of cr_roa_offset[i] is inferred to be equal to 0. In Table 4, nnlf_param_id[x][y] specifies the NNLF parameter index. When not present, the value of nnlf_param_id[cIdx][x][y] is inferred to be equal to 0. If nnlf_mode equals to 0, nnlf_prm_id[0][0] specifies the NNLF parameter index used for the current picture. Otherwise, nnlf_prm_id[x][y] specifies the NNLF parameter index used for the NNLF coding block at luma location (x,y) of all color component.

In some embodiments, the variable ParamId is set to nnlf_param_id[x][y], for all x value in range from 0 to PicWidthInNnlfBlocks−1, and y value in range from 0 to PicHeightInNnlfBlocks−1. In Table 4, use_nnlf[x][y] equal to 1 specifies that NNLF is enabled for the NNLF coding block at luma location (x,y) of all color component. In Table 4, use_nnlf[x][y] equal to 0 specifies that NNLF is disabled for the NNLF coding block at luma location (x,y) of all color component. When not present, the value of use_nnlf[x][y] is inferred to be equal to 0.

In some embodiments, a block level NNLF enabling flag and/or parameters are signaled independently for each color component.

TABLE 5
Example NNLF Parameters

| | Descriptor |
|---|---|
| nnlf_pic_parameters ( ) { | |
| nnlf_mode | u(1) |
| nnlf_scale_mode | ue(v) |
| if( nnlf_scale_mode == 1 ) { | |
| for( i = 0; i < nnlf_mode == 0 ? 1 : nnlf_max_num_params; i++) | |
| { | |
| y_nn_scale[ i ] | ue(v) |
| cb_nn_scale[ i ] | ue(v) |
| cr_nn_scale[ i ] | ue(v) |
| } | |
| } | |
| for( i = 0; i < nnlf_mode == 0 ? 1 : nnlf_max_num_params; i++ ) { | |
| y_roa_flag[i] | u(1) |
| if ( y_roa_flag[i] != 0 ) { | |
| y_roa_offset[i] | ue(v) |
| } | |
| cb_roa_flag[i] | u(1) |
| if ( cb_roa_flag[i] != 0 ) { | |
| cb_roa_offset[i] | ue(v) |
| } | |
| cr_roa_flag[i] | u(1) |
| if ( cr_roa_flag[i] != 0 ) { | |
| cr_roa_offset[i] | ue(v) |
| } | |
| } | |
| if( nnlf_mode == 0 ){ | |
| nnlf_param_id[0][0][0] | ue(v) |
| } else { | |
| for( y = 0; y < PicHeightInNnlfBlocks; y++) { | |
| for( x = 0; x < PicWidthInNnlfBlocks; x++) { | |
| for( cIdx = 0; cIdx < (ChromaFormatIdc != 0 ? 3 : 1); | |
| cIdx++){ | |
| use_nnlf[cIdx][x][y] | u(1) |
| if(NumParams != 1 && use_nnlf[cIdx][x][y]) { | |
| nnlf_param_id[cIdx][x][y] | ue(v) |
| } | |
| } | |
| } | |
| } | |
| } | |
| } | |

In some embodiments, block level NNLF enabling flag and/or parameters are signaled independently for each color component.

In some embodiments, a padding process is applied before filtering. Inputs to this process may comprise the picture sample array arrOrg, and the width nWidth and height nHeight variables. Output of this process may be a modified array arrPad.

In some embodiments, the block/picture is padded by zero. The picture sample array arrOrg zero padding process may be performed as following with the variable xMargin and yMargin equal to 8 for luma colour component and 4 for Cb and Cr colour component.

Snippet 1-Example Padding Logic

```
for (i = 0; i < nWidth; i++) {
  for (j = 0; j < nHeight; j++) {
    arrPad[ i + xMargin ][ j + yMargin ] = arrOrg[ i ][ j ];
  }
}
for (i = 0; i < xMargin; i++) {
  for ( j = 0; j < nHeight; j++ ) {
    arrPad[ i ][ j + yMargin ] = 0;
    arrPad[ i + xMargin + nWidth ][ j + yMargin ] = 0;
  }
}
for ( i = 0; i < nWidth + 2 * xMargin; i++ ) {
  for ( j = 0; j < yMargin; j++) {
    arrPad[ i ][ j + yMargin + nHeight ] = 0;
  }
}
for ( i = 0; i < nWidth + 2 * xMargin; i++) {
  for ( j = 0; j < yMargin; j++ ) {
    arrPad[ i ][ j ]=0;
  }
}
```

In some embodiments, the block/picture is padded by repeating the boundary pixel values. The variable xMargin and yMargin equal to 8 for luma colour component and 4 for Cb and Cr colour component.

Snippet 2-Example Padding Logic

```
for (i = 0; i < nWidth; i++) {
  for (j = 0; j < nHeight; j++) {
    arrPad[ i + xMargin ][ j + yMargin ] = arrOrg[ i ][ j ];
  }
}
for (i = 0; i < xMargin; i++) {
  for ( j = 0; j < nHeight; j++ ) {
    arrPad[ i ][ j + yMargin ] = arrOrg[ 0 ][ j ];
    arrPad[ i + xMargin + nWidth ][ j + yMargin ] = arrOrg
    [ nWidth − 1 ] [ j ];
  }
}
for ( i = 0; i < nWidth + 2 * xMargin; i++ ) {
  for ( j = 0; j < yMargin; j++) {
    arrPad[ i ][ j + yMargin + nHeight ] = arrOrg[ i ] [ nHeight − 1 ];
  }
}
for ( i = 0; i < nWidth + 2 * xMargin; i++) {
  for (j = 0; j < yMargin; j++ ) {
    arrPad[ i ][ j ]= arrOrg[ i ] [ 0 ];
  }
}
```

In some embodiments, the block/picture is padded by copying the values from the neighboring pixels of the reference block. In one example, the reference block is the collocated block of the motion vector of the current block. In another example, the reference block is the searched by template matching.

In some embodiments, the block/picture to be filtered and other side information (e.g., boundary strength, prediction information, and/or ibpPicture) are given to the neural network, and the output of the network is the filtered block/picture.

In some embodiments, inputs to the filtering process include: (i) the picture sample array recPictureL for the luma color component, (ii) when ChromaFormatIdc is not equal to 0, the picture sample array recPictureCb for the Cb color component, (iii) when ChromaFormatIdc is not equal to 0, the picture sample array recPictureCr for the Cr color component, (iv) the picture sample array predPictureL for the luma color component, (v) when ChromaFormatIdc is not equal to 0, the picture sample array predPictureCb for the Cb colour component, (vi) when ChromaFormatIdc is not equal to 0, the picture sample array predPictureCr for the Cr color component, (vii) the picture sample array bsPictureL for the luma color component, (viii) when ChromaFormatIdc is not equal to 0, the picture sample array bsPictureCb for the Cb color component, (ix) when ChromaFormatIdc is not equal to 0, the picture sample array bsPictureCr for the Cr colour component, (x) the picture sample array ibpPictureL for the luma colour component, (xi) a pair of variables (rx, ry) specifying the NnlfBlock location, (xii) the NNLF block width NnlfBlockWidth and height NnlfBlockHeight.

In some embodiments, output of this process include: (i) the modified array nnOutputVectorL for the luma colour component, (ii) when ChromaFormatIdc is not equal to 0, the modified array nnOutputVectorCb for the Cb colour component, and (iii) when ChromaFormatIdc is not equal to 0, the modified array nnOutputVectorCr for the Cr colour component.

In some embodiments, the location (xNnlfBlock, yNnlfBlock), specifying the top-left sample of the current NNLF block relative to the top-left sample of the current picture component cIdx, is derived as follows: (xNnlfBlock, yNnlfBlock)=(rx*NnlfBlock, ry*NnlfBlock) and (xSi, ySj)=(xNnlfBlock+i, yNnlfBlock+j). In some embodiments, the luma sample locations inside the current NNLF block are derived as follows: (xYi, yYj)=(xSi, ySj) and the Cb and Cr sample locations inside the current NNLF block are derived as follows: (xCi, yCj)=xSi*Sub WidthC, ySj*SubHeightC. In some embodiments, the variable SeqQP is derived as follows: SeqQP=26+pps_init_qp_minus26+QpOffset. In some embodiments, the variable QpOffset is derived as follows: QpOffset=(sh_slice_type!=I_SLICE?5*PrmId: 2*PrmId)*(TemporalId>=4? 1:−1).

In some embodiments, for all sample locations (xSi, ySj) and (xYi, yYj) with i=0 . . . NnlfBlockWidth−1 and j=0 . . . NnlfBlockHeight−1, the following applies. If PrmId [rx][ry] is equal to 0, nnlfPictureL [xSi][ySj] are not modified. Otherwise, the following ordered steps in Snippet 3 are applied.

Snippet 3-Example Vector Construction

```
The array nnlfInputVector of six elements is constructed as following:
  for ( i = 0; i < NnlfBlockHeight; i++)
    for ( j = 0; j < NnlfBlockHeight; j++)
      nnlfInputVector[0][i][j][0] = recPictureL[ xYi ][ yYj ]
      nnlfInputVector[0][i][j][1] = recPictureCb[ xCi ][ yCj ]
      nnlfInputVector[0][i][j][2] = recPictureCr[ xCi ][ yCj ]
      nnlfInputVector[1][i][j][0] = predPictureL [ xYi ][ yYj ]
      nnlfInputVector[1][i][j][1] = predPictureCb [ xCi ][ yCj ]
      nnlfInputVector[1][i][j][2] = predPictureCr [ xCi ][ yCj ]
      nnlfInputVector[2][i][j][0] = bsPictureL [ xYi ][ yYj ]
      nnlfInputVector[2][i][j][1] = bsPictureCb [ xCi ][ yCj ]
      nnlfInputVector[2][i][j][2] = bsPictureCr [ xCi ][ yCj ]
      nnlfInputVector[3][i][j] = SeqQp
      nnlfInputVector[4][i][j] = SliceQpY
      nnlfInputVector[5][i][j] = ibpPictureL[ xYi ][ yYj ]
The modified picture sample array nnOutputVectorL [ xYi ][ xYi ], nnOutput VectorCb [ xCi ][ xCi
] and nnOutputVectorCr [ xCi ][ xCi ] are derived as follows.
  for( c = 0; c < 4; c++ )
    for ( i = 0; i < n NnlfBlockHeight / 2; i++ )
      for ( j = 0; j < NnlfBlockWidth / 2; j++ )
        nnOutputVectorL [ xYi ][ xYi ] = nnOutputVector[i][j][c] + recPictureL[ xYi
        ][ yYj ]
      for ( i = 0; i < NnlfBlockHeight / 2; i++)
        for ( j = 0; j < NnlfBlockWidth / 2; j++ ) {
          nnOutputVectorCb [ xCi ][ yCi ] = nnOutputVector[i][j][4] +
          recPictureCb[ xCi ][ yCj ]
          nnOutputVectorCr [ xCi ][ yCi ] = nnOutput Vector[i][j][5] + recPictureCr[
          xCi ][ yCj ]
          nnOutputVectorL [ xYi ][ yYi ] = Clip3( 0, ( 1 << OutputScale ) − 1,
          nnOutputVectorL [ xYi ][ yYi ])
          nnOutputVectorCb [ xCi ][ yCi ] = Clip3(0, (1 << OutputScale) − 1,
          nnOutputVectorCb [ xCi ][ xCi ])
          nnOutputVectorCr [ xCi ][ yCi ] = Clip3( 0, (1 << OutputScale ) − 1,
          nnOutputVectorCr [ xCi ][ yCi ])
        }
```

In some embodiments, the block-level NNLF process is applied as follows.

Inputs to this process include a tensor InRec[3, h, w], a tensor InPred[3, h, w], a tensor InBS[3, h, w], a tensor InSeqQP[1, h, w], a tensor InSliceQPY[1, h, w], and a tensor InIBP[1, h, w]. In some embodiments, outputs from this process include a tensor OutRes[6, h/2, w/2].

In some embodiments, rec is assigned as results of quantized convolution with inputs of InRec, weight0Conv, weight0Bias, 3, 3, 3, 12, and 1. In some embodiments, pred is assigned as results of quantized convolution with inputs of InPred, weight1Conv, weight1Bias, 3, 3, 3, 8, and 1. In some embodiments, bs is assigned as results of quantized convolution with inputs of InBS, weight2Conv, weight2Bias, 1, 1, 3, 4, and 1. In some embodiments, seqQP is assigned as results of quantized convolution with inputs of InSeqQP, weight3Conv, weight3Bias, 1, 1, 1, 2, and 1. In some embodiments, sliceQP is assigned as results of quantized convolution with inputs of InSliceQPY, weight4Conv, weight4Bias, 1, 1, 1, 2, and 1. In some embodiments, ibp is assigned as results of quantized convolution with inputs of InIBP, weight5Conv, weight5Bias, 1, 1, 1, 2, and 1. In some embodiments, rec, pred, bs, seqQP, sliceQP and ibp are concatenated along the channel dimension and the result is assigned to x.

In some embodiments, x1=ConvAct(x, weight6Conv, weight6Bias, weight6Act, 1, 1, 30, 24, 1). In some embodiments, x2=ConvAct (x1, weight7Conv, weight7Bias, weight7Act, 3, 3, 24, 32, 2).

In some embodiments, xY[0] is set as x2 [0:16, h/2, w/2] and xC [0] is set as x2 [16:32, h/2, w/2]. In some embodiments, the following applies for i in range of 1 to 12, inclusive, and j in range of 1 to 6, inclusive: xY [i] is assigned with the result of ResiBlock(xY[I−1], weightConv[i], weightBias[i], weightAct[i], weightConv[i+1], weightBias[i+1], weightConv[i+2], weightBias[i+2], weightConv[i+3], weightBias[i+3], 16, 16, 64). xC[j] is assigned with the result of ResiBlock (xC[j−1], weightConv[j], weightBias[j], weightAct[j], weightConv[j+1], weightBias[j+1], weightConv[j+2], weightBias[j+2], weightConv[j+3], weightBias[j+3], 16, 16, 48). x3=SepConv(xY [12], weight8Conv, weight8Bias, weight9Conv, weight9Bias, 16, 16). x4=SepConv(xC [6], weight10Conv, weight10Bias, weight11Conv, weight11Bias, 16, 16). x5=ConvAct(x3, weight12Conv, weight12Bias, weight12Act, 1, 1, 16, 16, 1). x6=ConvAct(x4, weight13Conv, weight13Bias, weight13Act, 1, 1, 16, 16, 1). x7 is assigned as results of quantized convolution with inputs of x5, weight14Conv, weight14Bias, 3, 3, 16, 4, and 1. x8 is assigned as results of quantized convolution with inputs of x6, weight15Conv, weight15Bias, 3, 3, 16, 2, and 1. Concatenate x7 and x8 along the channel dimension and assign the result to OutRes.

The function of separable convolution is denoted as SepConv (x, weight0Conv, weight0Bias, weight1Conv, weight1Bias, cIn, cOut). In some embodiments, inputs to this function include: a tensor x [cIn, hIn, wIn], a tensor weight0Conv [cIn, cOut, kVer, kHor], a tensor weight0Bias [cOut], a tensor weight1Conv [cOut, cOut, kVer, kHor], a tensor weight1Bias [cOut], input channel size cIn, and output channel size cOut.

In some embodiments, the result of this function, a tensor x_out[cOut, hIn, wIn], is derived as follows: x0 is assigned with result of quantized convolution, with inputs of x, weight0Conv, weightOBias, 1, 3, cIn, cOut, 1. x_out is assigned with result of quantized convolution with inputs of x0, weight1Conv, weight1Bias, 3, 1, cOut, cOut, 1. The function of residual block is denoted as ResiBlock (x, weight0Conv, weightOBias, weight0Act, weight1Conv, weight1Bias, weight2Conv, weight2Bias, weight3Conv, weight3Bias, weight4Conv, weight4Bias, cIn, cOut, cAct). In some embodiments, inputs to this function include: a tensor x [cIn, h, w], a tensor weight0Conv [cIn, cAct, kVer, kHor], a tensor weightOBias [cAct], a tensor weight0Act [cAct], a tensor weight1Conv [cAct, cOut kVer, kHor], a tensor weight1Bias [cOut], a tensor weight2Conv [cOut, cOut, kVer, kHor], a tensor weight2Bias [cOut], a tensor weight3Conv [cOut, cOut, kVer, kHor], a tensor weight3Bias [cOut], a tensor weight4Conv [cOut, cOut, kVer, kHor], a tensor weight4Bias [cOut], input channel size cIn, output channel size cOut, and/or enlarged channel size cAct.

In some embodiments, the result of this function, a tensor x_out [c, h, w], is derived as follows: (i) x0=ConvAct (x, weight0Conv, weight0Bias, weight0Act, 1, 1, cIn, cAct, 1), (ii) x1 is assigned with result of quantized convolution with inputs of x0, weight1Conv, weight1Bias, 1, 1, cAct, cOut, 1. (iii) x2=SepConv (x1, weight2Conv, weight2Bias, weight3Conv, weight3Bias, cOut, cOut). (iv) x3 is assigned with result of quantized convolution with inputs of x2, weight4Conv, weight4Bias, 1, 1, cOut, cOut, 1. (v) x_out=x3+x.

In some embodiments, a clipping process is applied to the modified picture sample array nnOutputVectorL[xYi][xYi], nnOutputVectorCb[xCi][xCi] and nnOutputVectorCr [xCi][xCi]. In one example, the clipping is applied to round the output to bit depth as follows: (i) nnOutputVectorL [xYi][xYi]=Clip3 (0, 1023, (nnOutputVectorL [xYi][xYi]+(1<<(Shift−1)))>>Shift), (ii) nnOutputVectorCb [xCi][xCi]=Clip3 (0, 1023, (nnOutputVectorCb[xCi][xCi]+ (1<< (Shift−1)))>>Shift), and (iii) nnOutputVectorCr[xCi][xCi]=Clip3 (0, 1023, (nnOutputVectorCr[xCi][xCi]+ (1<<(Shift−1)))>>Shift).

In some embodiments, the NNLF filtered output array nnOutputVectorL[xYi][xYi], nnOutputVectorCb [xCi][xCi] and nnOutputVectorCr [xCi][xCi] can be further blended with the other filter outputs. In some embodiments, the NNLF filtered outputs are blended with the deblocking filter outputs. In one example, if nnlf_scale_mode does not equal to 0, the following applies: three parameters Shift, Shift2, and Offset are derived as Shift=OutputScale−Bitdepth, Shift2=Shift+ResidualScale, and Offset=(1<<Shift2)/2.

In some embodiments, the array BlendWeight is derived as follows:

If nnlf_scale_mode equals to 1, the syntax elements y_nn_scale, cb_nn_scale, and cr_nn_scale are signalled to represent the blending mode. BlendWeight [0][i]=y_nn_scale[i] for all integer i values in range from 0 to NumParams−1. BlendWeight[1][i]=cb_nn_scale[i] for all integer i values in range from 0 to NumParams−1. BlendWeight[2][i]=cr_nn_scale[i] for all integer i values in range from 0 to NumParams−1.

Otherwise, if nnlf_scale_mode equals to 1, the syntax elements y_nn_scale, cb_nn_scale, and cr_nn_scale are signalled to represent the blending mode.

Otherwise, if nnlf_scale_mode equals to 2, the variable BlendWeight[cIdx][i] equals to 0.75 for all integer cIdx values in range from 0 to 2, and i values in range from 0 to NumParams−1;

Otherwise, if nnlf_scale_mode equals to 3, the variable BlendWeight[cIdx][i] equals to 0.5 for all integer cIdx values in range from 0 to 2, and i values in range from 0 to NumParams−1.

In some embodiments, the array ResOffsetAdj is derived as follows: (i) ResOffsetAdj [0][i]=y_roa_offset[i] for all integer i values in range from 0 to NumParams−1, (ii) ResOffsetAdj [1][i]=cb_roa_offset[i] for all integer i values in range from 0 to NumParams−1, and (iii) ResOffsetAdj [2][i]=cr_roa_offset[i] for all integer i values in range from 0 to NumParams−1.

In some embodiments, the nnOutputVectorL[xYi][yYi], nnOutputVectorCb[xCi] [yCi] and nnOutputVectorCr[xCi][yCi] are modified as shown in Snippet 4.

Snippet 4-Example Vector Construction

```
if(BlendWeigth[0]>0){
  if((nnOutputVectorL [ xYi ][ yYi ] − ( recPictureL [ xYi ][ yYj ] << Shift ) )
  >=(ResOffsetAdj[0][rx][ry]<<Shift)) {
    nnOutputVectorL [ xYi ][ yYi ] = ( ( recPictureL [ xYi ][ yYj ] << Shift2 ) + ( (
    nnOutputVectorL [ xYi ][ yYi ] − ( recPictureL [ xYi ][ yYj ] << Shift ) − (
    ResOffsetAdj[0][rx][ry] << Shift ) ) * BlendWeight[ 0 ][ rx ][ ry ] + Offset ) >> Shift2
  } else if( ( nnOutputVectorL[ xYi ][ yYi ] − ( recPictureL[ xYi ][ yYj ] << Shift ) ) <= ( −
  ResOffsetAdj[ 0 ][ rx ][ ry ] << Shift ) ) {
    nnOutputVectorL[ xYi ][ yYi ] = ( ( recPictureL[ xYi ][ yYj ] << Shift2 ) + (
    nnOutputVectorL[ xYi ][ yYi ] − ( r recPictureL [ xYi ][ yYj ] << Shift ) + ( ResOffsetAdj[
    0 ][ rx ][ ry ] << Shift ) ) * BlendWeight[ 0 ][ rx ][ ry ] + Offset ) >> Shift2
  } else {
    nnOutputVectorL [ xYi ][ yYi ] = ((recPictureL [ xYi ][ yYj ] << Shift2 ) + (
    nnOutputVectorL[ xYi ][ yYi ] − ( recPictureL[ xYi ][ yYj ] << Shift ) ) * BlendWeight[ 0
    ][ rx ][ ry ] + Offset ) >> Shift2
  }
}
if(BlendWeight[1]>0){
  if((nnOutputVectorCb [ xCi ][ yYi ] − (recPictureCb [ xCi ][ yCj ] << Shift ) ) >= (
  ResOffsetAdj[ 1 ][ rx ][ ry ] << Shift ) ) {
    nnOutputVectorCb[ xCi ][ yCi ] = ( ( recPictureCb[ xCi ][ yCj ] << Shift2 ) + ( (
    nnOutputVectorCb[ xCi ][ yCi ] − ( recPictureCb[ xCi ][ yCj ] << Shift ) − ( ResOffsetAdj[
    1 ][ rx ][ ry ] << Shift ) ) * BlendWeight[ 1 ][ rx ][ ry ] + Offset ) >> Shift2
  }else if( ( nnOutputVectorCb[ xCi ][ yCi ] − (recPictureCb[ xCi ][ yCj ] << Shift ) ) <= (−
  ResOffsetAdj[ 1 ][ rx ][ ry ] << Shift ) ) {
    nnOutputVectorCb[ xCi ][ yCi ] = ( ( recPictureCb[ xCi ][ yCj ] << Shift2 ) + (
    nnOutputVectorCb[ xCi ][ yCi ] − ( recPictureCb[ xCi ][ yCj ] << Shift ) + (ResOffsetAdj[
    1 ][ rx ][ ry ] << Shift ) ) * BlendWeight[ 1 ][ rx ][ ry ] + Offset ) >> Shift2
  } else {
    nnOutputVectorCb [ xCi ][ yCi ] = ( ( recPictureCb[ xCi ][ yCj ] << Shift2 ) +
    (nnOutputVectorCb [xCi ][ yCi ] − ( recPictureCb[ xCi ][ yCj ] << Shift ) ) * BlendWeight[
    1 ][ rx ][ ry ] + Offset ) >> Shift2
  }
}
if(BlendWeight[2]>0){
  if( ( nnOutputVectorCr[ xCi ][ yYi ] − (recPictureCr[ xCi ][ yCj ] << Shift ) ) >= ( ResOffsetAdj[
  2 ][ rx ][ ry ] << Shift ) ) {
    nnOutputVectorCr[ xCi ][ yCi ] = ( ( recPictureCr[ xCi ][ yCj ] << Shift2 ) + ( (
    nnOutputVectorCr[ xCi ][ yCi ] − ( recPictureCr[ xCi ][ yCj ] << Shift ) − ( ResOffsetAdj[
    2 ][ rx ][ ry ] << Shift ) ) * BlendWeight[ 2 ][ rx ][ ry ] + Offset ) >> Shift2
  } else if( ( nnOutputVectorCr[ xCi ][ yCi ] − (recPictureCr[ xCi ][ yCj ] << Shift ) ) <= ( −
  ResOffsetAdj[ 2 ][ rx ][ ry ] << Shift ) ) {
    nnOutputVectorCr[ xCi ][ yCi ] = ( ( recPictureCr[ xCi ][ yCj ] << Shift2 ) + (
    nnOutputVectorCr[ xCi ][ yCi ] − (recPictureCr [ xCi ][ yCj ] << Shift ) + ( ResOffsetAdj[
    2 ][ rx ][ ry ] << Shift ) ) * BlendWeight[ 2 ][ rx ][ ry ] + Offset ) >> Shift2
  } else {
    nnOutputVectorCr[ xCi ][ yCi ] = ( ( recPictureCr[ xCi ][ yCj ] << Shift2 ) + (
    nnOutputVectorCr[ xCi ][ yCi ] − ( recPictureCr[ xCi ][ yCj ] << Shift ) ) * BlendWeight[
    2 ][ rx ][ ry ] + Offset ) >> Shift2
    }
}
```

In some embodiments, the NNLF filtered outputs are blended with the unfiltered reconstructed outputs. In some embodiments, the NNLF filtered outputs are blended with the sample adaptive offset filtered outputs. In some embodiments, the NNLF filtered outputs are blended with the adaptive loop filtering outputs.

In some embodiments, a clipping process is applied to the modified picture sample array nnOutputVectorL [xYi][xYi], nnOutputVectorCb [xCi][xCi] and nnOutputVectorCr [xCi][xCi] after blending. In one example, the clipping is applied to round the output to bit depth as shown in Snippet 5.

Snippet 5-Example Vector Construction

```
nnOutputVectorL [ xYi ][ yYi ] = Clip3( 0, ( 1 << BitDepth ) − 1, nnOutputVectorL[ xYi ][ yYi ] )
if ( ChromaFormatIdc != 0) {
  nnOutputVectorCb [ xCi ][ yCi ] = Clip3(0, ( 1 << BitDepth ) − 1, nnOutputVectorL[ xCi ][ yCi
  ])
  nnOutputVectorCr [ xCi ][ yCi ] = Clip3(0, ( 1 << BitDepth ) − 1, nnOutputVectorL[ xCi ][ yCi
  ])
}
```

In some embodiments, the syntax required for NNLF is signaled via corresponding VCN_NAL structures. In some embodiments, NNLF syntax is separated into sequence level to be put into VCM_NAL_SRD and picture level to be put into VCM_NAL_PRD. In some embodiments, the sequence-level NNLF data is put interleaved with VCM_NAL_CVD units.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data comprising a plurality of blocks. The system determines (554) whether a neural network-based filter is to be applied to a block of the plurality of blocks. When the neural network-based filter is to be applied to the block, the system applies (556) the neural network-based filter to the block. The system forgoes (558) applying the neural network-based filter to the block when the neural network-based filter is not to be applied to the block. As described previously, the encoding process may mirror the decoding processes described herein (e.g., loop filtering). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream of video data, the video data comprising a plurality of blocks; (ii) reconstructing a block of the plurality of blocks; (iii) parsing a syntax element from the bitstream, the syntax element indicating whether a neural network-based filter is to be applied to the reconstructed block; (iv) when the syntax element indicates that the neural network-based filter is to be applied to the reconstructed block, applying the neural network-based filter to the reconstructed block; and (v) not applying the neural network-based filter to the reconstructed block when the syntax element indicates that the neural network-based filter is not to be applied to the reconstructed block. In this way, a usage flag and/or parameter(s) of a neural network-based in-loop filter are signaled, e.g., in the raw byte sequence payloads (RBSP) in VCM NAL unit.

(A2) In some embodiments of A1, applying the neural network-based filter comprises applying padding the reconstructed block prior to filtering. For example, a padding process is applied before filtering. In some embodiments, the padding process inputs comprise a picture sample array, a width variable, and a height variable. As an example, padding is applied before a convolution kernel to ensure block size is not reduced by the convolution.

(A3) In some embodiments of A2, applying the padding to the reconstructed block comprises padding with zero pixel values. For example, the block/picture is padded by zero. In some embodiments, the zero padding process sets all padding samples to a value of zero. In some embodiments, the zero padding is performed by iterating through the margin regions and assigning zero values to each sample location. For example, for a block with dimensions nWidth by nHeight and margins xMargin and yMargin, the padding samples at locations (i, j) where i is less than xMargin or i is greater than or equal to xMargin plus nWidth are set to zero. In some embodiments, zero padding is applied to the top, bottom, left, and right margins of the block. In some embodiments, zero padding provides a neutral input to the neural network-based filter for samples outside the block boundary.

(A4) In some embodiments of A2 or A3, applying the padding to the reconstructed block comprises copying one or more boundary pixel values. For example, the block/picture is padded by repeating the boundary pixel values. In some embodiments, applying the padding comprises applying a gradient-based padding. In some embodiments, applying the padding to the reconstructed block comprises copying one or more neighboring pixel values. For example, the block/picture is padded by copying the values from the neighboring pixels of the reference block. The reference block may be the collocated block of the motion vector of the current block. The reference block may be searched by template matching. In some embodiments, the reference block is a temporal reference block. In some embodiments, the reference block is a spatial reference block.

(A5) In some embodiments of any of A1-A4, the neural network-based filter is applied using information of the reconstructed block and additional coded information. For example, the neural network-based filter may have side information input, such as boundary strength, prediction information, and/or ibpPicture information). In some embodiments, the inputs to the neural network-based filter comprise one or more of: a picture sample array for a first color component (e.g., a reconstructed picture, a prediction picture, a bsPicture, and/or an ibpPicture), a reconstructed picture sample array for a second/third color components (e.g., a reconstructed picture, a prediction picture, a bsPicture, and/or an ibpPicture), one or more parameters specifying the reconstructed block location, and/or one or more parameters specifying the reconstructed block dimensions.

(A6) In some embodiments of A5, the additional coded information comprises quantization information. For example, inputs to the neural network-based filter may comprise one or more reconstructed values, one or more prediction values, one or more quantization values, and/or one or more IBP values. The IBP values indicate the prediction mode information of the current block (e.g., the value can be 0 to 7 with each value indicating a type of prediction mode). The IBP values can be used to refer to frame types (e.g., intra frame, predicted frame, bi-predicted frame), such as those described previously).

(A7) In some embodiments of any of A1-A6, applying the neural network-based filter comprises clipping an output of the neural network-based filter. For example, a clipping process may be applied to the modified picture sample array (e.g., for each color component). In some embodiments, the clipping reduces the output bit depth to match a source/internal bit depth.

(A8) In some embodiments of A7, the clipping is applied after the output of the neural network-based filter is combined with one or more other outputs for the reconstructed block. For example, a clipping process is applied to the modified picture sample array after blending (e.g., blending with an output of a deblocking filter, sample adaptive offset filter, adaptive loop filter, unfiltered sample, or other output).

(A9) In some embodiments of any of A1-A8, applying the neural network-based filter comprises obtaining a neural network output, and the method further comprises combining the neural network output with one or more other outputs for the reconstructed block. In some embodiments, the neural network output comprises residual values that are added to the reconstructed samples to produce filtered samples. For example, nnOutputVectorL [xYi][yYi] equals nnOutputVector [i][j][c] plus recPictureL [xYi][yYj]. In some embodiments, the combining comprises blending the neural network output with another filter output using a blend weight (BlendWeight). In some embodiments, the blend weight is signaled in the bitstream (e.g., y_nn_scale, cb_nn_scale, cr_nn_scale). In some embodiments, the blend weight is derived based on a scale mode syntax element (nnlf_scale_mode). For example, when nnlf_scale_mode equals 2, the blend weight equals 0.75, and when nnlf_scale_mode equals 3, the blend weight equals 0.5. In some embodiments, the combining further comprises applying a residual offset adjustment (ResOffsetAdj) based on signaled offset values (e.g., y_roa_offset, cb_roa_offset, cr_roa_offset). In some embodiments, the combining is performed independently for each color component.

(A10) In some embodiments of A9, the one or more other outputs comprise at least one of: (i) an output of a deblocking filter applied to the reconstructed block, (ii) an output of a sample adaptive offset filter applied to the reconstructed block, (iii) an output of an adaptive loop filter applied to the reconstructed block, and (iv) an unfiltered sample of the reconstructed block. For example, NNLF filtered outputs may be blended with the deblocking filter outputs. As another example, the NNLF filtered outputs can be blended with the unfiltered reconstructed outputs. As another example, the NNLF filtered outputs can be blended with the sample adaptive offset filtered outputs. As another example, the NNLF filtered outputs can be blended with the adaptive loop filtering outputs.

(A11) In some embodiments of any of A1-A10, the syntax element is signaled via a raw byte sequence payload (RBSP) of the video bitstream. In some embodiments, the syntax element is signaled in a VCM NAL unit. In some embodiments, the syntax element is signaled in a sequence restoration data RBSP (sequence_restoration_data_rbsp). In some embodiments, the syntax element is signaled in a picture restoration data RBSP (picture_restoration_data_rbsp). In some embodiments, the RBSP contains additional neural network filter parameters when the enabling flag indicates that the filter is enabled. In some embodiments, the syntax element is entropy coded within the RBSP. In some embodiments, the syntax element is signaled using a fixed-length code (e.g., u(1) for a flag) or a variable-length code (e.g., ue(v) for parameter values).

(A12) In some embodiments of any of A1-A10, the syntax element comprises a sequence-level syntax. For example, a sequence-level enabling flag may be signaled in sequence restoration (SRD) syntax. In some embodiments, sequence-level NNLF parameters are signaled when nnlf_seq_parameters( ) is called.

(A13) In some embodiments of any of A1-A10, the syntax element comprises a picture-level syntax. For example, a picture-level enabling flag may be signaled in the picture restoration data RBSP syntax. In some embodiments, the syntax element comprises a block-level syntax. In some embodiments, the picture-level syntax element comprises prd_nnlf_enabled_flag, where a value of 1 specifies that the neural network in-loop filter is enabled for the current picture and a value of 0 specifies that the neural network in-loop filter is disabled for the current picture. In some embodiments, picture-level NNLF parameters are signaled when nnlf_pic_parameters( ) is called. In some embodiments, the picture-level parameters comprise nnlf_mode, which specifies the NNLF processing mode (e.g., picture-level or block-level). In some embodiments, the picture-level parameters comprise nnlf_scale_mode, which specifies the blending mode used for NNLF. In some embodiments, the picture-level parameters comprise scale values (e.g., y_nn_scale, cb_nn_scale, cr_nn_scale) that specify weights used for blending with deblocking filter results. In some embodiments, the picture-level parameters comprise residual offset adjustment flags and values (e.g., y_roa_flag, y_roa_offset) for each color component. In some embodiments, block-level parameters comprise use_nnlf[x][y], which specifies whether NNLF is enabled for the NNLF coding block at location (x, y). In some embodiments, block-level parameters comprise nnlf_param_id[x][y], which specifies the NNLF parameter index for the block at location (x, y).

(A14) In some embodiments of any of A1-A13, the video data comprises a plurality of color components, and syntax element indicates whether the neural network-based filter is to be applied to a first color component. For example, a block-level NNLF enabling flag and/or parameters may be signaled independently for each color component. In some embodiments, a separate syntax element is signaled for each color component of the plurality of color components. In some embodiments, the plurality of color components comprises a luma component (Y), a first chroma component (Cb), and a second chroma component (Cr). In some embodiments, the block-level enabling flag use_nnlf[cIdx][x][y] is signaled for each color component index cIdx. In some embodiments, the block-level parameter index nnlf_param_id[cIdx][x][y] is signaled for each color component index cIdx. In some embodiments, the number of color components is determined based on the chroma format indicator (ChromaFormatIdc), where ChromaFormatIdc not equal to 0 indicates three color components and ChromaFormatIdc equal to 0 indicates one color component. In some embodiments, different filter parameters are applied to luma and chroma components. In some embodiments, the neural network-based filter processes luma and chroma components through separate processing paths with different complexity levels.

(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes: (i) receiving video data comprising a plurality of blocks; (ii) determining whether a neural network-based filter is to be applied to a block of the plurality of blocks; (iii) when the neural network-based filter is to be applied to the block, applying the neural network-based filter to the block; and (iv) not applying the neural network-based filter to the block when the neural network-based filter is not to be applied to the block. In some embodiments, the determining is based on a rate-distortion optimization process. In some embodiments, the determining is based on content characteristics of the block. In some embodiments, the determining is based on a region of interest (ROI) analysis. For example, the neural network-based filter may be enabled when the ROI area is within a certain range of the total frame area. In some embodiments, the determining is performed at a sequence level, a picture level, or a block level. In some embodiments, the method further comprises reconstructing the block prior to applying the neural network-based filter. In some embodiments, the method further comprises storing the filtered block in a reference picture memory for use in subsequent encoding operations.

(B2) In some embodiments of B1, the method further comprises signaling a syntax element in a video bitstream, the syntax element indicating whether the neural network-based filter is to be applied to the block. In some embodiments, the syntax element is signaled in a raw byte sequence payload (RBSP) of the video bitstream. In some embodiments, the syntax element is signaled at a sequence level (e.g., srd_nnlf_enabled_flag in sequence restoration data). In some embodiments, the syntax element is signaled at a picture level (e.g., prd_nnlf_enabled_flag in picture restoration data). In some embodiments, the syntax element is signaled at a block level (e.g., use_nnlf[x][y] for each block location). In some embodiments, the method further comprises signaling additional filter parameters when the syntax element indicates that the filter is enabled. In some embodiments, the additional filter parameters comprise scale values, offset values, and/or parameter indices. In some embodiments, the syntax element is signaled independently for each color component.

(B3) In some embodiments of B1 or B2, applying the neural network-based filter comprises applying padding the block prior to filtering. In some embodiments, the padding comprises zero padding. In some embodiments, the padding comprises copying boundary pixel values. In some embodiments, the padding comprises copying neighboring pixel values from a reference block. In some embodiments, the padding margin equals 8 for luma color components and 4 for chroma color components. In some embodiments, the padding is applied symmetrically around all boundaries of the block. In some embodiments, the padding enables the neural network-based filter to process samples near block boundaries. In some embodiments, the padding size corresponds to the receptive field of the neural network-based filter.

(B4) In some embodiments of any of B1-B3, applying the neural network-based filter comprises clipping an output of the neural network-based filter. In some embodiments, the clipping constrains sample values within a valid range determined by the bit depth of the video data. In some embodiments, the clipping is performed using a Clip3 function. In some embodiments, the clipping is applied independently to each color component. In some embodiments, the clipping is applied after the neural network output is added to the reconstructed samples. In some embodiments, the clipping is applied after the neural network output is blended with other filter outputs. In some embodiments, the clipping is applied after rounding the output to the output bit depth.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A14, and B1-B4).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A14 and B1-B4). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream of video data, the video data comprising a plurality of blocks;
reconstructing a block of the plurality of blocks;
parsing a syntax element from the bitstream, the syntax element indicating whether a neural network-based filter is to be applied to the reconstructed block;
when the syntax element indicates that the neural network-based filter is to be applied to the reconstructed block, applying the neural network-based filter to the reconstructed block; and
not applying the neural network-based filter to the reconstructed block when the syntax element indicates that the neural network-based filter is not to be applied to the reconstructed block.

2. The method of claim 1, wherein applying the neural network-based filter comprises applying padding the reconstructed block prior to filtering.

3. The method of claim 2, wherein applying the padding to the reconstructed block comprises padding with zero pixel values.

4. The method of claim 2, wherein applying the padding to the reconstructed block comprises copying one or more boundary pixel values.

5. The method of claim 1, wherein the neural network-based filter is applied using information of the reconstructed block and additional coded information.

6. The method of claim 5, wherein the additional coded information comprises quantization information.

7. The method of claim 1, wherein applying the neural network-based filter comprises clipping an output of the neural network-based filter.

8. The method of claim 7, wherein the clipping is applied after the output of the neural network-based filter is combined with one or more other outputs for the reconstructed block.

9. The method of claim 1, wherein applying the neural network-based filter comprises obtaining a neural network output, and wherein the method further comprises combining the neural network output with one or more other outputs for the reconstructed block.

10. The method of claim 9, wherein the one or more other outputs comprise at least one of:
an output of a deblocking filter applied to the reconstructed block;
an output of a sample adaptive offset filter applied to the reconstructed block;
an output of an adaptive loop filter applied to the reconstructed block; and
an unfiltered sample of the reconstructed block.

11. The method of claim 1, wherein the syntax element is signaled via a raw byte sequence payload (RBSP) of the video bitstream.

12. The method of claim 1, wherein the syntax element comprises a sequence-level syntax.

13. The method of claim 1, wherein the syntax element comprises a picture-level syntax.

14. The method of claim 1, wherein the video data comprises a plurality of color components, and wherein syntax element indicates whether the neural network-based filter is to be applied to a first color component.

15. A method of video encoding performed at a computing system having memory and one or more processors, the method comprising:
receiving video data comprising a plurality of blocks;
determining whether a neural network-based filter is to be applied to a block of the plurality of blocks;
when the neural network-based filter is to be applied to the block, applying the neural network-based filter to the block; and
not applying the neural network-based filter to the block when the neural network-based filter is not to be applied to the block.

16. The method of claim 15, further comprising signaling a syntax element in a video bitstream, the syntax element indicating whether the neural network-based filter is to be applied to the block.

17. The method of claim 15, wherein applying the neural network-based filter comprises applying padding the block prior to filtering.

18. The method of claim 15, wherein applying the neural network-based filter comprises clipping an output of the neural network-based filter.

19. A non-transitory computer-readable storage medium storing a video bitstream that is generated by a video encoding method, the video bitstream comprising:
coded information for a plurality of blocks; and
a syntax element indicating whether a neural network-based filter is to be applied to a block of the plurality of blocks;
wherein the video encoding method comprises:
determining whether a neural network-based filter is to be applied to the block;
when the neural network-based filter is to be applied to the block, applying the neural network-based filter to the block; and
not applying the neural network-based filter to the block when the neural network-based filter is not to be applied to the block.

20. The non-transitory computer-readable storage medium of claim 19, wherein the syntax element is signaled via a raw byte sequence payload (RBSP) of the video bitstream.
